(19) United States
(12) Patent Application Publication
(10) Pub. No.: US 2007/0194111 A1
(43) Pub. Date: Aug. 23, 2007

(54) Energy activated retail receipt system

(76) Inventors: Eric T. Martin, Corvallis, OR (US); Daryl E. Anderson, Corvallis, OR (US); Andrew Koll, Corvallis, OR (US); Andrew L. Van Brocklin, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/358,960

(22) Filed: Feb. 21, 2006

(51) Int. Cl. G06K 15/00; G06K 19/00

(52) U.S. Cl. 235/383; 235/487

(57) ABSTRACT

This invention relates to a receipt generating apparatus, comprising: an article that has been purchased; and a receipt portion located substantially on the article such that the receipt portion includes an energy activated material section upon which selected receipt markings are placed.

### BACKGROUND OF THE INVENTION

1. Field of the Invention

This invention relates to a receipt generating apparatus, comprising: an article that has been purchased; and a receipt portion located substantially on the article such that the receipt portion includes an energy activated material section upon which selected receipt markings are placed.

2. Description of the Related Art

Prior to the present invention, as set forth in general terms above and more specifically below, it is known, that in the case of many small purchases for which product return is very unlikely, or for which a customer record of the purchase is not needed, such as a convenience store or fast food purchase, a purchase receipt is produced, but the receipt is often immediately discarded by the customer or sales associate. While the generation of the receipt is a requirement for such purposes, it can be costly in the form of consumables used and time used to maintain consumables supplies and generate the receipt. Consequently, a more advantageous receipt generating system, then, would be provided if the receipt could be directly attached to the purchased product and/or product packaging.

It is also known, that in the case of larger or more expensive purchases where the customer desires to keep a record of the purchase (i.e., in case a product return is necessary in the future), the purchaser must generally keep the original packaging as well as the separate receipt. The receipt, generally in the form of a small paper slip, can be easily lost or destroyed. Again, the generation of the receipt can be costly in terms of consumables and time. Therefore, a further advantageous receipt generating system, then, would be provided if the receipt could be directly attached to the purchased product and/or product packaging.

It is apparent from the above that there exists a need in the art for a receipt generating system that can generate a receipt that is directly attached to the purchased product and/or product packaging. It is a purpose of this invention to fulfill this and other needs in the art in a manner more apparent to the skilled artisan once given the following disclosure.

### SUMMARY OF THE INVENTION

Generally speaking, an embodiment of this invention fulfills these needs by providing a receipt generating apparatus, comprising: an article that has been purchased; and a receipt portion located substantially on the article such that the receipt portion includes an energy activated material section upon which selected receipt markings are placed.

In certain preferred embodiments, the receipt portion may be an adhesive price tag. Also, the receipt portion may be an integral part of the product packaging or the product itself.

In another further preferred embodiment, a receipt generating system is described that can generate a receipt that is directly attached to the purchased product and/or product packaging.

The preferred receipt generating apparatus, according to various embodiments of the present invention, offers the following advantages: ease-of-use; excellent receipt generating characteristics; and excellent receipt retaining characteristics. In fact, in many of the preferred embodiments, these factors of ease-of-use, excellent receipt generation, and excellent receipt retention are optimized to an extent that is considerably higher than heretofore achieved in prior, known receipt generating apparatus.

The above and other features of the present invention, which will become more apparent as the description proceeds, are best understood by considering the following detailed description in conjunction with the accompanying drawings, wherein like characters represent like parts throughout the several views and in which:

### BRIEF DESCRIPTION OF THE DRAWINGS

FIG. 1 is a schematic illustration flowchart of an energy activated receipt, according to one embodiment of the present invention;

FIG. 2 is a schematic illustration flowchart of another energy activated receipt, according to one embodiment of the present invention;

FIG. 3 is a schematic illustration of the energy activated receipt attached to a product, according to another embodiment of the present invention;

FIG. 4 is a schematic illustration of a point-of-sale device for use with the energy activated receipt, according to another embodiment of the present invention;

FIG. 5 is a schematic illustration of the energy activated receipt as an integral part of a product, according to another embodiment of the present invention.

### DETAILED DESCRIPTION OF THE INVENTION

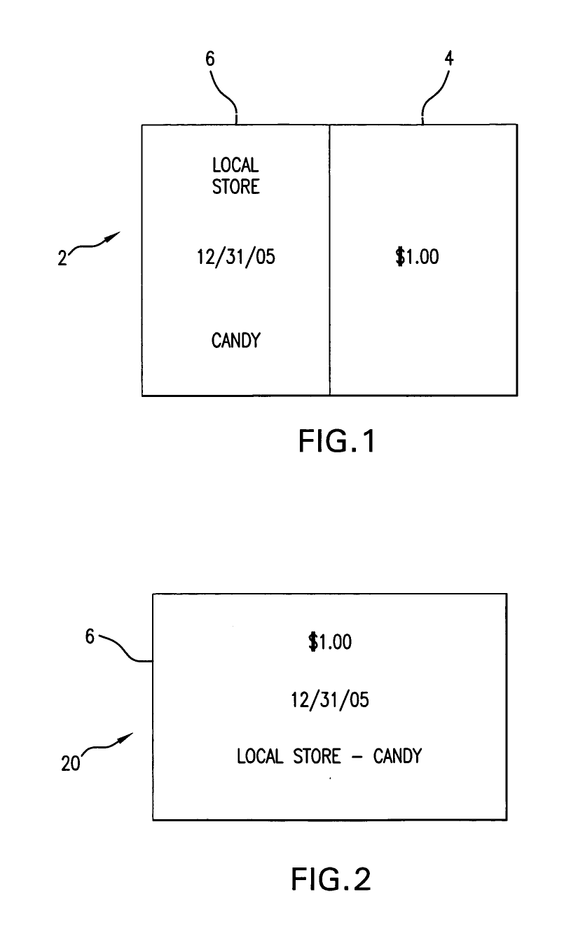

With reference first to FIG. 1, there is illustrated one preferred embodiment for use of the concepts of this invention. With respect to FIG. 1, there is illustrated energy activated receipt 2. Receipt 2 includes, in part, preprinted section 4 and energy activated section 6. The idea behind receipt 2 is that for small/inexpensive purchases for which a purchase receipt is generally not maintained by the customer, receipt 2 can be an adhesive price tag that includes the preprinted section 4 and the energy activated section 6. In this manner, receipt 2 is placed upon the item to be purchased and then further receipt information is placed upon activated section 6 at the point-of-sale, which will be described later (FIG. 4). Conversely, receipt 2 can be prepared at the point-of-sale and conventionally attached to the product. It is to be understood that receipt 2 could also be integrated into the product packaging (i.e., receipt 2 could be screen printed, for example, onto the packaging at the factory and later marked with the selected marks at the point-of-sale).

As illustrated in FIG. 1, preprinted section 4 may, for example, include the price. The information in energy activated section 6 may then be printed out at the point-of-sale (FIG. 4). As can be seen in FIG. 1, such information as, but not limited to, the name of store, the date of purchase, and the item purchased, can be created at the point-of-sale on the energy activated section 6. It is to be understood that a variety of information can be created on energy activated section 6. It is also to be understood that the information created on energy activated section 6 could be human-readable or in some other format, such as a barcode. Preferably, the energy activated material is any suitable material that creates a mark when a light source (laser) or heat activation (UV or IR) source is impinged upon the material, such as a laser writable material. In this manner, the light or heat activation source can be accurately operated in order to create precise marks in energy activated material section 6.

With respect to FIG. 2, there is illustrated another energy activated receipt 20. Receipt 20 includes, in its entirety, energy activated section 6. In this embodiment, information located on energy activated section 6 is created entirely at the point-of-sale. It is to be understood that receipt 20 can be attached to the product prior to the information being placed upon energy activated section 6. Conversely, receipt 20 can be prepared at the point-of-sale and conventionally attached to the product. As can be seen in FIG. 2, such information as, but not limited to, the name of store, the date of purchase, and the item purchased, can be created at the point-of-sale on the energy activated section 6. It is to be understood that a variety of information can be created on energy activated section 6.

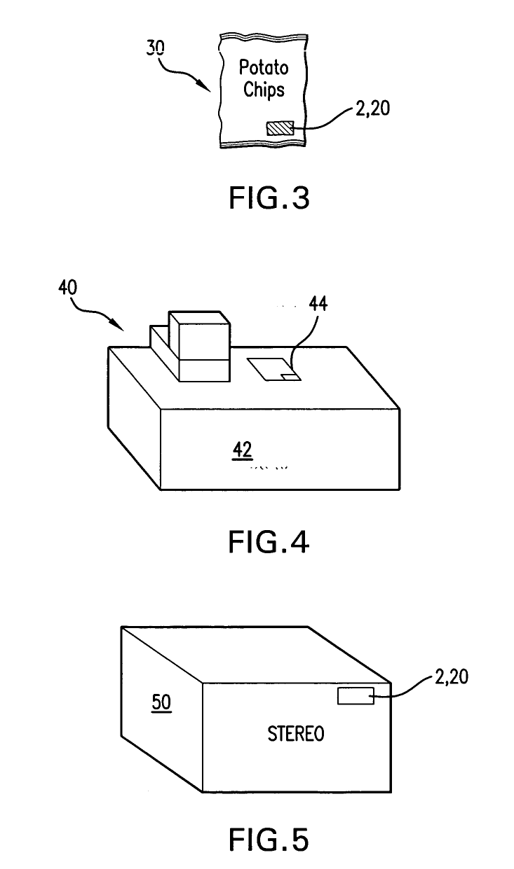

With respect to FIG. 3, product 30 is illustrated. As shown in FIG. 3, product 30 includes receipt 2, 20. As discussed earlier, receipt 2, 20 can be attached to product 30 prior to the information being placed upon energy activated section 6 (FIGS. 1 and 2). Conversely, receipt 2, 20 can be prepared at the point-of-sale and conventionally attached to product 30. As can be seen in FIG. 3, the legal requirements to provide the customer with a purchase receipt is therefore satisfied with minimal expenditure of time and/or materials in producing receipt 2, 20.

With respect to FIG. 4, point-of-sale system 40 is illustrated. Point-of-sale system 40 includes, in part, point-of-sale device 42 and marking device 44. During the preparation of receipt 2, 20, marking device 44 is activated to create an energy beam (not shown). Preferably, marking device 44 is a conventional laser light source that is capable of producing a laser beam. Also, marking device 44 can be a conventional UV or IR heat activation source. As the energy beam impinges upon receipt 2, 20, selected markings, such as those shown in FIGS. 1 and 2, are created. In this manner, receipt 2, 20 is created. It is also to be understood that information created on receipt 2, 20 could be human-readable or in some other format, such as a barcode.

With respect to FIG. 5, for more costly purchases such as home electronics, where the purchaser wishes to maintain a record of the purchase, receipt 2, 20 can be integrated into product 50. For instance, the container 50 in which the product is packaged may contain a region in which receipt 2, 20 is located. At the point-of-sale, the marking device 44 (FIG. 4) records/writes the desired receipt data onto receipt 2, 20 in either human readable format or some other format. It is to be understood that a receipt region can be located on the product itself. In this manner, the receipt region can serve as a receipt 2, 20 and as a personal identifier of ownership on the product. Because the present invention allows for creating receipt 2, 20 through a transparent covering, marking of receipt 2, 20 can be accomplished by transmitting the energy beam through a transparent portion of the product packaging (i.e., cellophane product packaging or a hole in the product container).

Once given the above disclosure, many other features, modifications or improvements will become apparent to the skilled artisan. Such features, modifications or improvements are, therefore, considered to be a part of this invention, the scope of which is to be determined by the following claims.

What is Claimed is:

1. A receipt generating apparatus, comprising:
an article that has been purchased; and
a receipt portion located substantially on the article such that the receipt portion includes an energy activated material section upon which selected receipt markings are placed.

2. The receipt generating apparatus, as in claim 1, wherein the apparatus is further comprised of:
an energy beam generating apparatus.

3. The receipt generating apparatus, as in claim 2, wherein the energy beam generating apparatus is further comprised of:
a laser light source that is capable of producing a laser beam.

4. The receipt generating apparatus, as in claim 2, wherein the energy beam generating apparatus is further comprised of
heat activation source.

5. The receipt generating apparatus, as in claim 1, wherein the energy activated material is further comprised of:
any suitable material that creates a mark when an energy source is impinged upon the material.

6. A product receipt, comprising:
a product that has been purchased; and
a receipt portion located substantially on the product such that the receipt portion includes an energy activated material section upon which selected receipt markings are placed.

7. The product receipt, as in claim 6, wherein the energy activated material is further comprised of:
any suitable material that creates a mark when an energy source is impinged upon the material.

8. The product receipt, as in claim 6, wherein the product receipt is further comprised of:
a preprinted section.

9. A method for generating a product receipt, comprising:
interacting a product to be purchased with a point of sale of device; and
creating selected marks on a receipt of purchase of the product such that the receipt includes a receipt portion that further includes an energy activated material section upon which the selected receipt markings are placed.

10. The method, as in claim 9, wherein the interacting step is further comprised of:
operating an energy beam generating apparatus to create an energy beam.

11. The method, as in claim 10, wherein the operating step is further comprised of:
operating a laser light source that is capable of producing a laser beam.

12. The method, as in claim 10, wherein the operating step is further comprised of:
operating a heat source.

13. The method, as in claim 9, wherein the method is further comprised of:
placing the product receipt upon the product prior to creating selected marks.

14. The method, as in claim 9, wherein the method is further comprised of:
placing the product receipt upon the product after creating selected marks.
